(19) United States
(12) Patent Application Publication
(10) Pub. No.: US 2024/0391516 A1
(43) Pub. Date: Nov. 28, 2024

(54) STEERING ACTUATOR FOR A STEER-BY-WIRE STEERING SYSTEM

(71) Applicant: Schaeffler Technologies AG & Co. KG, Herzogenaurach (DE)

(72) Inventors: Andreas WOELLNER, Nürnberg (DE); Lukas HOLLER, Nürnberg (DE)

(21) Appl. No.: 18/696,760

(22) PCT Filed: Aug. 29, 2022
(86) PCT No.: PCT/DE2022/100641

§ 371 Date: Mar. 28, 2024

(30) Foreign Application Priority Data
Sep. 29, 2021 (DE) 10 2021 125 214.8

(51) Int. Cl. B62D 5/00; B62D 5/04

(52) U.S. Cl. CPC B62D 5/001; B62D 5/0421; B62D 5/0442

(57) ABSTRACT

A steering actuator for a steer-by-wire steering system of a motor vehicle including a rotation stop, which is disposed in the force flow from a drive unit to a steering rod of the wheel module. The rotation stop is formed by a disk assembly and a cooperation of an engagement contour with a locking pin. The rotation stop can be arranged in such a way that installation space is saved, since the rotation stop requires only an axial installation space in the region of the wheel module, but no radial installation space.

### CROSS-REFERENCE TO RELATED APPLICATIONS

This application is the U.S. National Phase of PCT Appl. No. PCT/DE2022/100641 filed Aug. 29, 2022, which claims priority to DE 10 2021 125 214.8, filed Sep. 29, 2021, the entire disclosures of which are incorporated by reference herein.

### TECHNICAL FIELD

The present disclosure relates to a steering actuator for a steer-by-wire steering system of a motor vehicle, in particular a multi-track passenger car, having a rotation limiting unit arranged in the power flow from a drive unit to a steering rod of the wheel module.

### BACKGROUND

Similar to conventional mechanical steering systems, steer-by-wire steering systems for motor vehicles receive manual steering commands from the driver via an input unit. Such commands or inputs can be given, for example, by turning a steering wheel. The steering wheel is connected in a non-rotatable manner via a steering shaft of a steering unit. However, the steering shaft is not necessarily mechanically connected to the wheels to be steered via a steering gear, but can interact with angle of rotation or torque sensors of the steering unit. These sensors acquire the given steering command and transmit an electrical control signal determined therefrom to a steering actuator, which sets a corresponding steering angle of the wheel or wheel module by means of an electric actuator.

### SUMMARY

With conventional purely mechanical steering systems, the maximum number of steering wheel turns is mechanically fixed. In this regard, the existing mechanical connection also ensures that the steered wheels move within defined stops. Steer-by-wire steering systems lack this mechanical connection, so that both a limitation of the possible steering wheel turns and a steering angle limitation of the wheels or wheel modules must be provided. A steering angle limitation of the wheels or wheel modules must be provided so that in the event of a fault related to the steering actuator, no rotation beyond the maximum permissible steering angle occurs, which could damage components such as cables, coolant lines, brake lines, angle sensors or wheel housings and attachments. A steering angle limitation is implemented via a mechanical stop in the region of the steering actuator, wherein it must be ensured that the mechanical stop is designed in such a way that all of the required steering angle range can be covered.

There is a constant need to design a steering actuator for a steer-by-wire steering system of a motor vehicle as simply and cost-effectively as possible.

It is an object of the present disclosure to demonstrate measures which enable a simple and cost-effective steering angle limitation of a steering actuator for a steer-by-wire steering system of a motor vehicle.

One embodiment relates to a steering actuator for a steer-by-wire steering system of a motor vehicle, in particular a multi-track passenger car, having a drive unit for initiating a steering movement, a rotatably mounted steering rod for transferring a steering movement initiated by the drive unit to a wheel of the motor vehicle, a gear unit arranged between the drive unit and the steering rod to apply a gear ratio to the steering movement initiated by the drive unit and transferred to the wheel of the motor vehicle, and a rotation stop arranged in the power flow from the drive unit to the steering rod for limiting the steering movement of the wheel, wherein the rotation stop is formed by a disc assembly comprising at least two discs which can rotate concentrically with respect to one another, wherein one disc has a locking pin engaging in an engagement contour of the other disc which is bent along a circumference.

The steering actuator can be accommodated in a wheel module. The wheel module can support the wheel for moving the motor vehicle. The steering rod can be rotatably mounted on a support frame of the motor vehicle. A wishbone can be provided, wherein the steering rod can be connected to the wishbone in order to form an articulation point that is radially offset from the wheel. A longitudinal swing arm can be articulated on the articulation point. A suspension spring and a shock absorber can sit between the wishbone and the swing arm. To steer the motor vehicle, a torque can be applied via the steering rod in order to turn the wheel in a steering head bearing. An electrically driven wheel hub drive can be provided between the swing arm and the wheel. The wheel hub drive enables the wheel of the wheel module to be driven separately. In particular, multiple wheel modules can be provided for a multi-track passenger car, each of which can be driven individually by the respective wheel hub drive.

Via the gear unit of the steering actuator, a gear ratio can be applied to the drive torque of the drive unit for conversion to the steering torque required for the respective application and transferred to the wheel in order to bring about the intended change in steering angle. The gear unit can be formed by different gear types or contain different gear types. The gear type can be a planetary gear. A combination of a spur gear and worm gear can also be provided. In rare cases, it can be expedient and sufficient to dispense with the gear unit if the drive unit has a sufficiently high drive torque.

The rotation stop of the steering actuator saves installation space, as it is integrated directly into the line of power flow of the applied steering torque. An external stop can be dispensed with, for example in the region of the steering head bearing. The rotation stop can be arranged at different points within the power flow between the drive unit and the steering rod, depending on the respective embodiment of the wheel module. The drive motor can be an electromechanical motor or actuator. The two discs of the disc assembly can have at least approximately the same diameter. The two discs of the disc assembly can be held against one another via an axial bearing and can be rotated against one another via the axial bearing. Regarding the rotatability of the two discs with respect to one another, it is considered sufficient if at least one of the discs is rotatable so that a relative rotation of both discs with respect to one another can be achieved.

In a preferred embodiment of the present disclosure, the rotation stop is arranged between the drive unit and the gear unit. This arrangement has the advantage of requiring only little installation space, as no gear ratio has yet been applied and only the relatively low torque of the drive unit needs to be supported.

In an alternatively preferred embodiment of the present disclosure, the rotation stop is arranged between the gear unit and the steering rod. The advantage of this arrangement is that the rotation stop only needs to be designed for a small rotational movement, as a gear ratio has already been applied to the rotational movement of the drive unit by means of the gear unit. The resulting increased steering torque can be compensated for by a correspondingly stronger dimensioning of the rotation stop. In a specific embodiment, the gear unit can comprise a worm gear and the rotation stop can be arranged on the output side of the worm gear. Depending on the specific application or installation space conditions, it may again be expedient for the rotation stop to be arranged on one of the two sides of the worm wheel.

In a particularly preferred embodiment, the engagement contour is formed as an elongated hole bent along the circumference of the disc or as a bent elongated groove. Overall, it is particularly expedient if the elongated hole or the elongated groove is located on the radially outer circumference of the disc. It is also conceivable that the engagement contour is also located on an outer circumference of the disc and is exposed radially outwards. In this regard, the engagement contour is ultimately formed by radially extending contact shoulders of the disc, against which the respective locking pin can run in the circumferential direction.

A further preferred embodiment provides for the disc having the engagement contour to be arranged in a non-rotatable manner. This advantageously allows for this disc to be connected directly or indirectly to the drive unit, the gear unit or the steering rod.

In particular, it is preferred if the disc having the locking pin has a drive flange which is arranged in the rotational axis and which passes axially through a central bore of the other disc. This makes it easier to integrate this disc into the respective interface between the drive unit and gear unit or the gear unit and steering rod.

In particular for the embodiment in which the rotation stop is arranged in front of the gear unit, it is considered advantageous if the disc assembly comprises at least one intermediate disc, wherein the intermediate disc has an engagement contour bent along the circumference and a locking pin. This ensures that the rotations required in front of the gear unit between the two end stops of the wheel module can be covered by the rotation stop. In a specific embodiment, each of the locking pins is aligned parallel to the rotational axis with respect to the respective disc, pointing in the same axial direction.

### BRIEF SUMMARY OF THE DRAWINGS

In the following, the present disclosure is explained by way of example with reference to the attached drawings using preferred exemplary embodiments, wherein it is possible for the features presented below to represent an aspect of the present disclosure both individually and in combination. In the figures:

FIGS. 1a) and 1b): show a schematic representation of a variant of a steering actuator with a rotation stop,

FIGS. 2a) and 2b): show a schematic representation of a further variant of a steering actuator with a rotation stop,

FIGS. 3a) and 3b): show details of a first embodiment of the rotation stop and

FIGS. 4a) and 4b): show details of a further embodiment of the rotation stop.

### DETAILED DESCRIPTION

The following figures describe different variants of a steering actuator 10, each of which has a rotation stop 20, wherein the rotation stop 20 can have a different position within the power flow of the steering actuator 20 due to the design of the variant of the steering actuator 20. The power flow refers to the course of the steering torque applied by a drive unit 12, which can suitably be an electric motor, and transferred to a wheel. A wheel module, which contains the steering actuator, as well as the entire vehicle itself are not shown here.

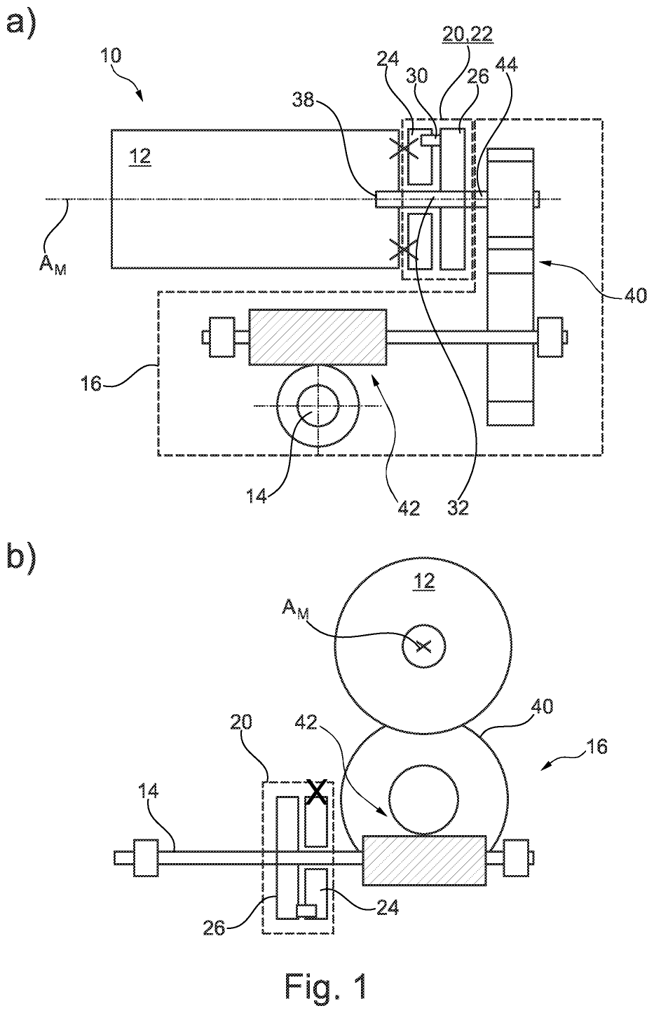

FIG. 1a) shows a steering actuator 10 in a schematic representation. In structural terms, the steering actuator 10 comprises a drive unit 12 for initiating a steering movement, a rotatably mounted steering rod 14 for transferring the steering movement to a wheel of the motor vehicle, and a gear unit 16 arranged between the drive unit 12 and the steering rod 14. A gear ratio can be applied to the steering movement initiated by the drive unit 12 such as is suitable for the wheel via the gear unit 16. In principle, it is intended that the rotations initiated by the drive unit 12 are stepped down with a gear ratio greater than 1. This results in an increase in the applied torque. The steering rod 14 is shown here in an axial view, so that the steering rod 14 is perpendicular to the drawing plane. In the variant shown here, the gear unit 16 comprises two partial gears, namely a spur gear 40 and a worm wheel gear 42.

In addition, the steering actuator 10 comprises a rotation stop 20, which is positioned between the drive unit 12 and the gear unit 16 in the variant of the steering actuator 10 shown in FIG. 1a). In structural terms, the rotation stop 20 comprises a disc assembly 22, with at least a first disc 24 and a second disc 26, which are rotatable relative to one another about the drive axis A_{M} of the drive unit 12. The term “rotatable relative to one another” is understood to mean that one of the two discs 24, 26 is held in a non-rotatable manner relative to the drive unit 12 and the other of the two discs 26, 24 is rotatable relative to the first disc 24, 26. In the present case, the first disc 24 is connected to the drive unit 12 in a non-rotatable manner, which is symbolized by the “X” above and below the rotational axis. On the end face facing the second disc, the first disc 24 forms an engagement contour, which is yet to be described, for a locking pin 30 of the second discs 26. The locking pin 30 sits in the end face of the second disc 26 facing the first disc 24. The second disc 26 has a drive flange 32 in the drive axis A_{M}, which passes axially through a central bore 34 of the other disc 24 and via which the second disc 26 is connected in a non-rotatable manner to a drive shaft 38 of the drive unit 12. On the other axial side, the second disc 26 is connected in a non-rotatable manner to an input shaft 44 of the gear unit 16. Consequently, during a steering movement initiated by the drive unit 12, a rotation about the drive axis A_{M}, only the second disc 26 and the input shaft 44 rotate, whereas the first disc 24 is stationary and can enter into an operative connection with the second disc 24 via the engagement contour 28 with the locking pin 30 in a manner yet to be described.

FIG. 1b) shows the same variant of the steering actuator 10 as FIG. 1a), but with a different position of the rotation stop 20 within the power flow of the steering actuator 20. Compared with FIG. 1a), the view in FIG. 1b) is an axial view of the drive unit 12 and the gear unit 16, so that the worm wheel 19 of the worm gear 18 and the steering rod 14 are shown in the drawing plane. The rotation stop 20 is arranged in the power flow between the gear unit 16 and the steering rod 14, or the rotation stop 20 is arranged on the output side of the gear unit 16. The representation shown in FIG. 1b) is purely schematic in nature, so that, for example, the fixing of the first disc 24 in a non-rotatable manner is not shown, but a permanently attached tube element, in which the worm wheel 19 of the worm gear 18 and the steering rod 14 can be housed, can be provided for this purpose, for example. Based on the positioning of the rotation stop 20 shown in FIG. 1b), an alternative positioning of the rotation stop 20 on the side of the worm wheel 19 facing away from the steering rod 14 is also conceivable. A separate representation of this alternative positioning is not provided here.

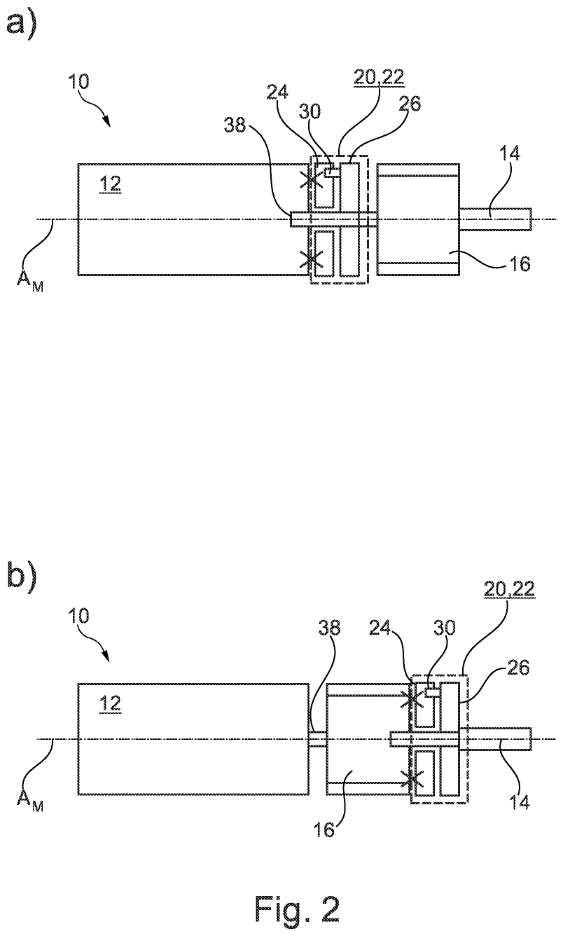

FIG. 2a) shows a variant of the steering actuator 10 in which the gear unit 16 is designed as a planetary gear. In this context, the drive axis A_{M} and the steering rod 14 are arranged coaxially with respect to one another. As already described for FIG. 1a), the rotation stop 20 is arranged between the drive unit 12 and the gear unit 16. Consequently, the non-rotatable arrangement of the first disc 24 and the rotatability of the second disc 26 are provided for accordingly. FIG. 2b) shows the same variant of the steering actuator 10 as FIG. 2a), but with a position of the rotation stop 20 between the gear unit 16 and the steering rod 14 or a position on the output side of the gear unit 16.

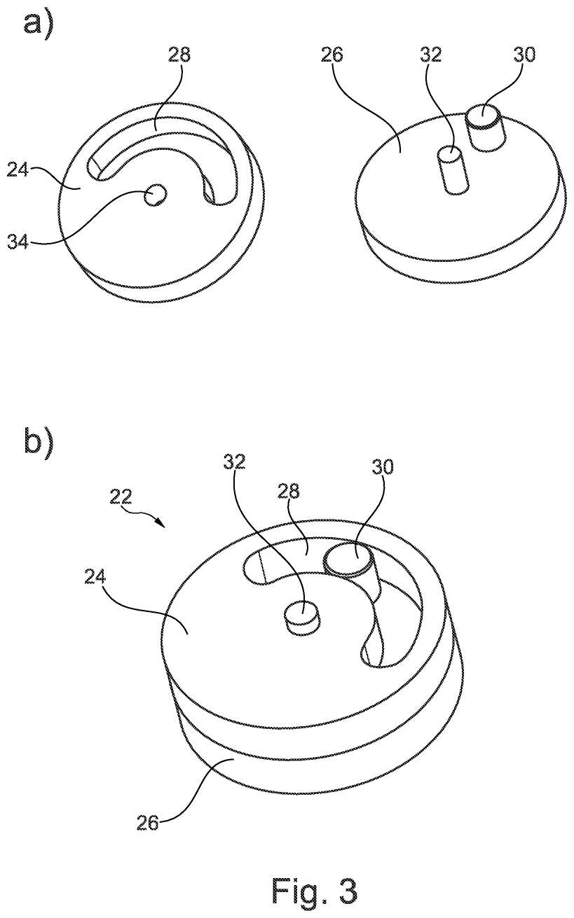

FIGS. 3a) and 3b) show the disc assembly 22 of the rotation stop 20 as an individual representation of the two discs 24, 26—FIG. 3a)—and as an assembly of both discs 24, 26—FIG. 3b). These are purely schematic representations. In addition to the axial bore 34, the first disc 24 has an engagement contour 28 bent along a circumference, in which the locking pin 30 of the second disc 26 is seated or engages in the assembly situation. It is shown here that the engagement contour 28 is formed as an elongated hole bent along the circumference of the disc 24. It is also conceivable for the engagement contour 28 to be formed by a bent elongated groove. The function of the rotation stop 20 now results from the fact that the first disc 24 is held in a non-rotatable manner as described above and the second disc 26 executes the steering movement initiated by the drive unit 12 synchronously, but the steering movement is limited by the maximum possible circumferential travel that the locking pin 30 of the second disc 26 can cover in the engagement contour 28. FIG. 3b) shows an assembly situation in which the locking pin 30 is centered in the engagement contour in relation to the two end stops of the elongated hole.

From a practical design standpoint, the engagement contour 28 can extend from the center position to both sides over a circumferential section of, for example, 95°. This embodiment is particularly expedient if the positioning of the rotation stop 20 shown in FIGS. 1b) and 2b) is used, namely positioning after the gear unit 16. Since a gear ratio is applied to the steering movement or the steering angle as it passes through the gear unit, so that the steering angle on the output side is in a range of, for example, +/−95° for the constructively intended driving maneuvers of the vehicle, this maximum steering angle range can be mechanically limited via the rotation stop 20.

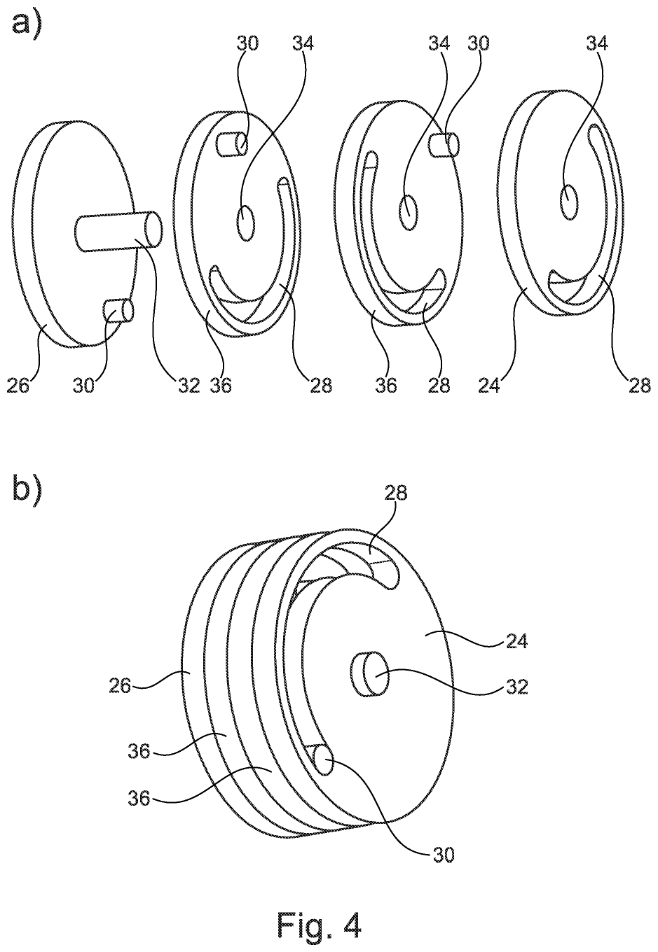

FIGS. 4a) and 4b) show an embodiment of the rotation stop 20, which is particularly expedient if the positioning of the rotation stop 20 shown in FIGS. 1a) and 2a) is used, namely positioning between the drive unit 12 and the gear unit 16. In this embodiment of the rotation stop 20, one or more intermediate discs 36 are provided, which are seated between the first disc 24 and the second disc 26. Each intermediate disc 36 has an engagement contour 28 bent along the circumference and a locking pin 30. While the locking pin 30 of the intermediate disc 36 engages in the engagement contour 28 of the first disc 24, the locking pin 30 of the second disc 26 is seated in the engagement contour 28 of the intermediate disc 36. In addition, the intermediate disc 36 has a central bore 34 through which the drive flange 32 of the second disc 26 passes. FIG. 4b) shows the assembly situation of the rotation stop 20 in the embodiment with the two discs 24, 26 and two intermediate discs 36.

When positioning the rotation stop 20 between the drive unit 12 and the gear unit 16, it is necessary for the rotation stop 20 to be able to cover the entire rotation range or angular range of the drive unit 12 before the right-hand or, correspondingly, the left-hand mechanical stop is reached. Consequently, if one assumes a rotation stop 20 with two intermediate discs 36 as shown here, then this is able to provide an angular range of, for example, 3×95° to each side from a central position, i.e. starting from a central position, the drive unit 12 can rotate approximately ¾ of a total rotation before the respective right-hand or left-hand stop of the rotation stop 20 becomes effective and prevents further rotation. However, an angular range deviating from 95° can also be appropriate, for example 3×150°. This would allow for a rotation range of more than one rotation to be covered.

In all of the embodiments of the rotation stop 20 shown and described, the discs 24, 26 can be designed to be partially or completely integral with the adjacent components or can be incorporated into the adjacent components in terms of installation space.

The described embodiments of the steering actuator 10 with the rotation stop 20 are used in a steer-by-wire steering system for safety reasons and, in particular, to protect components such as cables, coolant lines, brake lines or angle sensors in the region of a wheel module or the wheel housing and attachments. The rotation stop 20 can, in particular, be arranged in such a way that installation space is saved, since the rotation stop requires only an axial installation space in the region of the wheel module, but no radial installation space, which is generally scarcer.

### LIST OF REFERENCE SYMBOLS

10 Steering actuator
12 Drive unit
14 Steering rod
16 Gear unit
18 Worm gear
19 Worm wheel
20 Rotation stop
22 Disc assembly
24 Disc
26 Disc
28 Engagement contour
30 Locking pin
32 Drive flange
34 Bore
36 Intermediate disc
38 Drive shaft
40 Spur gear
42 Worm wheel gear
44 Input shaft

What is claimed is:

1-10. (canceled)

11: A steering actuator for a steer-by-wire steering system of a motor vehicle comprising:
a drive unit for initiating a steering movement;
a rotatably mounted steering rod for transferring a steering movement initiated by the drive unit to a wheel of the motor vehicle;
a gear unit arranged between the drive unit and the steering rod to apply a gear ratio to the steering movement initiated by the drive unit and transferred to the wheel of the motor vehicle; and
a rotation stop arranged in a power flow from the drive unit to the steering rod for limiting the steering movement of the wheel,
wherein the rotation stop is formed by a disc assembly comprising at least two discs which can rotate concentrically with respect to one another, wherein one disc has a locking pin engaging in an engagement contour of the other disc which is bent along a circumference.

12: The steering actuator according to claim 11, wherein the rotation stop is arranged between the drive unit and the gear unit.

13: The steering actuator according to claim 11, wherein the rotation stop is arranged between the gear unit and the steering rod.

14: The steering actuator according to claim 13, wherein the gear unit comprises a worm gear and the rotation stop is arranged on an output side of the worm gear.

15: The steering actuator according to claim 14, wherein the rotation stop is arranged on one of the two sides of a worm wheel of the worm gear.

16: The steering actuator according to claim 11, wherein the engagement contour is formed as an elongated hole bent along the circumference of the disc or as a bent elongated groove.

17: The steering actuator according to claim 11, wherein the disc having the engagement contour is arranged in a non-rotatable manner.

18: The steering actuator according to claim 11, wherein the disc is having the locking pin as a drive flange, wherein the drive flange is arranged in a rotational axis A_{M} and the drive flange is passing axially through a central bore of the other disc.

19: The steering actuator according to claim 11, wherein the disc assembly comprises at least one intermediate disc, wherein the intermediate disc has an engagement contour bent along the circumference and a locking pin.

20: The steering actuator according to claim 19, wherein each of the locking pins is aligned parallel to a rotational axis with respect to the respective disc, pointing in a same axial direction.

21: The steering actuator according to claim 11, wherein the at least two discs are concentrically mounted on a drive shaft of the drive unit.

22: The steering actuator according to claim 21, wherein one of the at least two discs is non-rotatably connected to the drive shaft.

23: The steering actuator according to claim 11, wherein one of the at least two discs is non-rotatably connected to a drive shaft of the drive unit, and another of the at least two two discs is non-rotatably fixed in place.

24: The steering actuator according to claim 11, wherein the steering movement is limited by a maximum possible circumferential travel that the locking pin can move in the engagement contour.

25: The steering actuator according to claim 24, wherein the engagement contour is formed by an arcuate elongated hole, the locking pin being movable in the elongated hole between two ends of the elongated hole, the two ends defining the maximum possible circumferential travel.

26: A method of constructing a steering actuator for a steer-by-wire steering system of a motor vehicle comprising:
rotatably mounting a steering rod for transferring a steering movement initiated by a drive unit to a wheel of the motor vehicle;
arranging a gear unit between the drive unit and the steering rod to apply a gear ratio to the steering movement initiated by the drive unit and transferred to the wheel of the motor vehicle;
assembling a rotation stop by rotatably coupling a first disc and a second disc, the assembling including inserting a locking pin of the first disc along an engagement contour of the second disc such that the engagement contour limits rotational movement of the first disc via contact with the locking pin; and
arranging the rotation stop in a power flow from the drive unit to the steering rod for limiting the steering movement of the wheel.

27: The method as recited in claim 26, wherein the rotatably coupling of the first disc and the second disc includes coupling the first disc and the second disc together via a drive flange, a rotational movement between the first and second disc about the drive flange causing the pin to move along the engagement contour.

28: The method as recited in claim 26, wherein the engagement contour is formed by an arcuate elongated hole formed in the second disc, the pin being movable in the elongated hole between two ends of the elongated hole.

29: The method as recited in claim 26, wherein the arranging of the rotation stop in the power flow from the drive unit includes concentrically mounting the first disc and the second disc on a drive shaft of the drive unit.

30: The method as recited in claim 29, wherein the concentrically mounting of the first disc and the second disc on the drive shaft of the drive unit includes non-rotatably connecting one of the first disc and the second disc to the drive shaft.
